(19) United States
(12) Patent Application Publication
(10) Pub. No.: US 2025/0059722 A1
(43) Pub. Date: Feb. 20, 2025

(54) ATTACHMENT FOR AN EXCAVATOR

(71) Applicant: Galloway Steel Fabrications Limited, Downpatrick, County Down (GB)

(72) Inventor: Mark Galloway, Downpatrick, County Down (GB)

(21) Appl. No.: 18/720,450

(22) PCT Filed: Nov. 28, 2022
(86) PCT No.: PCT/EP2022/083516

§ 371 Date: Jun. 14, 2024

(30) Foreign Application Priority Data
Dec. 16, 2021 (GB) 2118237.3

(51) Int. Cl. E02F 3/20; E02F 3/24; E02F 9/28

(52) U.S. Cl. CPC E02F 3/20; E02F 3/24; E02F 9/2808

(57) ABSTRACT

An attachment for coupling to a quick coupler on a dipper arm of an excavator includes a rotor having a plurality of ground engaging teeth mounted thereon, and a motor for rotatably driving the rotor. The rotor may be rotatably mounted between a pair of side plates to extend substantially parallel to the ground, in use, with a cover plate extending between the side plates to extend over at least an upper portion of the rotor. Optionally, a coupling on the cover plate is adapted to engage a quick coupler provided on a distal end of the dipper arm of the excavator.

### CROSS REFERENCE TO RELATED APPLICATIONS

This present application is a § 371 national stage of International Application PCT/EP2022/083516, filed Nov. 28, 2022, which claims priority benefit of U.K. Pat. Application Ser. No. 2118237.3, filed Dec. 16, 2021, both of which are hereby incorporated herein by reference in their entireties.

### FIELD OF THE INVENTION

This invention relates to an attachment for an excavator and in particular to a ground working attachment for mounting on a dipper arm of an excavator to allow the excavator to be used for removing stones, debris and other unwanted material from the surface of the soil while conditioning and levelling the soil.

### BACKGROUND OF THE INVENTION

When landscaping and during other groundworks it is often desirable to remove stones, debris and other unwanted material from the surface of the soil, for example in preparation for sowing seeds or laying turf.

This is typically achieved by using a large fixed rake having curved tines mounted on or trailed behind a tractor, mini-loader or tracked vehicle. However, it can be difficult to operate such known vehicle mounted rakes on more difficult ground conditions, such as steep ground, soft ground, uneven ground, and ground with difficult or narrow access points. Furthermore, such known fixed stone rakes can typically only operate in one direction due to the curvature of the tines.

It is also known to provide powered stone rakes, wherein rake teeth are mounted on the periphery of a rotating drum to penetrate the soil and rake out stones and other debris as the drum is rotated. However, such powered stone rakes normally need to be mounted on a tractor or tracked vehicle, leading to the same accessibility problems as fixed rakes. Furthermore, it can be difficult to control the depth to which the teeth cut into the soil.

As well as removing stones and debris it is also required to condition and level the ground for subsequent operations. This typically requires the use of subsequent soil working implements, such as tillers and cultivators.

While excavators having buckets attached to a quick hitch or quick coupler on a distal end of a dipper arm are commonly used for digging and excavating the ground during a landscaping operation, such machines are not suited to the removal of stones, debris and other unwanted material from the surface of the soil. It is therefore an object of the present invention to provide an attachment to allow an excavator to be used for removing stones, debris and other unwanted material from the surface of the soil while conditioning and levelling the soil.

### SUMMARY OF THE INVENTION

According to the present invention there is provided an attachment adapted to be coupled to a quick coupler on a dipper arm of an excavator, the attachment including a rotor having a plurality of ground engaging teeth mounted thereon and a motor for rotatably driving the rotor.

The ground engaging teeth may be mounted on the rotor in one or more spirally extending rows.

The ground engaging teeth may include replaceable wear tips.

In one embodiment the rotor may be rotatably mounted between a pair of side plates to extend substantially parallel to the ground, in use, a cover plate extending between the side plates to extend over at least an upper portion of the rotor. A coupling may be provided on the cover plate adapted to engage a quick coupler provided on a distal end of a dipper arm of an excavator. The coupling may be provided on an upper wall of the cover plate substantially midway between the side plates. In one embodiment the coupling includes a pair of spaced apart first coupling bars adapted to be engaged by respective latching hooks of an excavator quick coupler, the first coupling bars extending substantially perpendicular to the side plates such that the attachment can be coupled to an arm of an excavator via the first coupling bars with the rotor extending transverse to the direction of movement of the arm. The coupling may include a pair of spaced apart second coupling bars adapted to be engaged by respective latching hooks of a quick coupler of an excavator, the second coupling bars extending between and substantially perpendicular to the first coupling bars and parallel to the side plates such that the attachment can be coupled to an arm of an excavator via the second coupling bars with the rotor substantially aligned with the direction of movement of the arm.

The motor, which may include a hydraulic or an electric motor, may be mounted on one of the side plates, the motor being drivingly coupled to the rotor via a drive chain or drive belt.

Optionally, a row of mutually spaced part skids are mounted between the side plates extending parallel to the side plates, wherein the skids are adapted to engage the ground to facilitate control of the depth to which the teeth of the rotor extend into the ground, in use. The skids may include elongate tines or plates arranged parallel to one another and mounted on transversely extending support bars extending between the side plates. A distal end of each skid may extend beyond the side plates to enable the distal ends of the skids to be used as a rake when the attachment is held in an orientation with the distal ends of the skids facing downwardly. The distal ends of the skids may be shaped to define pointed teeth.

A ground engaging roller may be mounted between the side plates to extend parallel to the rotor on an opposite side of the rotor to the skids. Optionally, the ground engaging roller is mounted to be adjustable in height with respect to the rotor. In one embodiment the ground engaging roller may be mounted between roller support arms, each roller support arm being pivotally coupled to a respective side plate about a common pivot axis extending parallel to the rotor, an adjustable linkage extending between the respective side plate and the respective support arm to allow the height of the ground engaging roller to be adjusted with respect to the rotor by adjusting the angle of each support arm with respect to the respective side plate. Each adjustable linkage may include a threaded rod.

The ends of the ground engaging roller may be mounted in bearings provided on the roller support arms.

The ground engaging roller may be provided with radially extending teeth extending from the outer surface thereof to allow the roller to assist in conditioning soil.

These and other objects, advantages, purposes and features of the present invention will become apparent upon review of the following specification in conjunction with the drawings.

### BRIEF DESCRIPTION OF THE DRAWINGS

A ground working attachment for an excavator in accordance with an embodiment of the present invention will now be described, by way of example only, with reference to the accompanying drawings, in which:

FIG. 1 is a perspective view of an attachment in accordance with an embodiment of the present invention coupled to a quick coupler at a distal end of a dipper arm of an excavator;

FIGS. 2 to 4 are different perspective views of the attachment of FIG. 1;

FIG. 5 is an overhead view of the attachment of FIG. 1;

FIG. 6 is a view from below of the attachment of FIG. 1;

FIG. 7 is a side view of the attachment of FIG. 1; and

FIG. 8 is a side view of the attachment of FIG. 1 showing hidden detail.

### DETAILED DESCRIPTION OF THE DRAWINGS

As illustrated in the drawings, a ground working attachment 1 for attachment to an excavator or back hoe for use in removing stones, debris and other unwanted material from the surface of the soil while conditioning and levelling the soil, and in accordance with an embodiment of the present invention, includes a rotor 2 rotatably mounted between a pair of side plates 4,6 joined by a cover plate 8, the cover plate 8 extending over the top of the rotor 2, the rotor 2 having a plurality of ground engaging teeth 10 mounted thereon (FIGS. 2-4 and 6). In the embodiment shown the ground engaging teeth 10 are arranged on the rotor in one or more spirally arranged rows, although other patterns of teeth are envisaged.

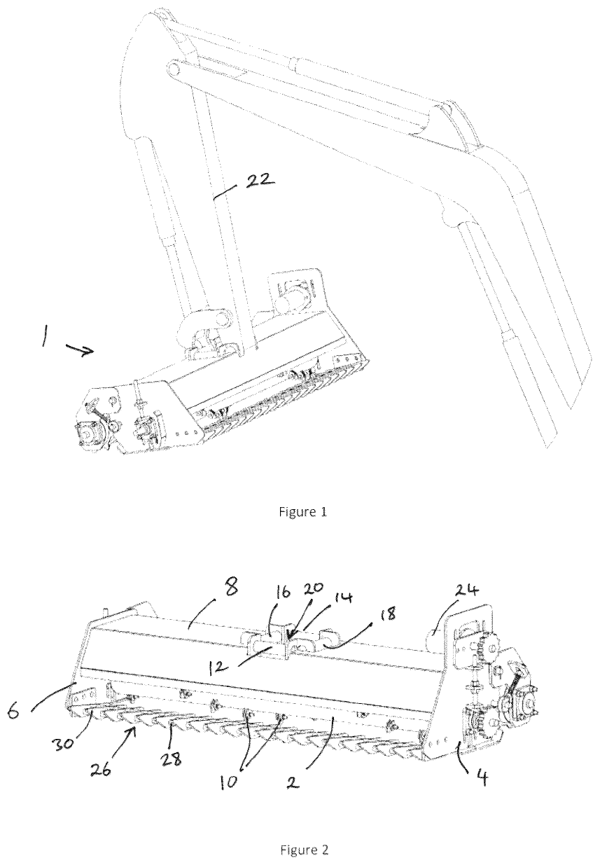

First and second pairs of suitably spaced coupling bars 12,14,16,18 are provided on respective opposing sides of an opening or recess 20 on the upper wall of the cover plate 8, the first and second pairs of coupling bars being arranged perpendicular to one another with the first pair 12,14 arranged perpendicular to the side plates 4,6 and the second pair 16,18 arranged parallel to the side plates 4,6, whereby the latching hooks of an excavator quick coupler (not shown) provided at a distal end of a dipper arm 22 of a back hoe may be engaged with selected first or second pairs of coupling bars 12,14,16,18 to couple the ground working attachment to the dipper arm 22 of an excavator in a desired orientation, with the rotor 2 extending transverse to the direction of movement of the dipper arm 22 when the quick coupler is attached to the first pair of coupling bars 12,14 (as shown in FIG. 1) or with the rotor 2 aligned with the direction of movement of the dipper arm 22 when the quick coupler is attached to the second pair of coupling bars 16,18.

A drive motor 24 is mounted on one of the side plates for driving the rotor via a suitable chain and sprocket arrangement or via a belt and pulleys. The motor 24 is optionally a hydraulic motor driven via a supply of hydraulic fluid from the excavator.

Alternatively, the motor may be an electric motor. The motor 24 may be reversible to drive the rotor in either direction.

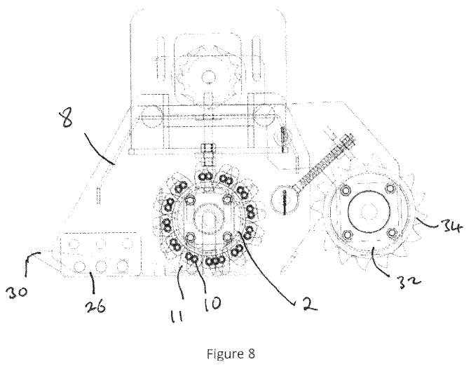

As best illustrated in FIGS. 6 and 8, each tooth 10 of the rotor 2 may include a replaceable wear tip 11, which may be bolted to the remainder of the respective tooth to allow replacement when worn.

In the illustrated embodiment a row of mutually spaced part skids 26 are mounted between the side plates 4,6 extending parallel to one another and to the side plates 4,6, wherein the skids 26 are adapted to engage the ground to one side of the rotor 2 to facilitate control of the depth to which the teeth of the rotor extend into the ground, in use. The skids 26 include elongate tines arranged parallel to one another and mounted on transversely extending support bars 28 extending between the side plates 4,6.

A distal end 30 of each skid 26 may terminate in a point extending beyond the side plates 4,6 to enable the distal ends 30 of the skids 26 to be used as a rake when the attachment is held in an orientation with the distal ends of the skids facing downwardly, allowing material loosened by the teeth 10 of the rotor 2 to be cleared from the ground by manipulating the attachment such that the skids 26 point downwardly and then drawings the skids across the ground using the dipper arm of the excavator.

The skids may be detachable from the attachment if they are not required.

A ground engaging roller 32, having axially spaced groups of radially extending teeth 34, may be mounted between the side plates 4,6 to extend parallel to the rotor 2 on an opposite side of the rotor to the skids 26. The ground engaging roller 32 may be mounted to be adjustable in height with respect to the rotor 2, thereby providing a height control function for the rotor 2.

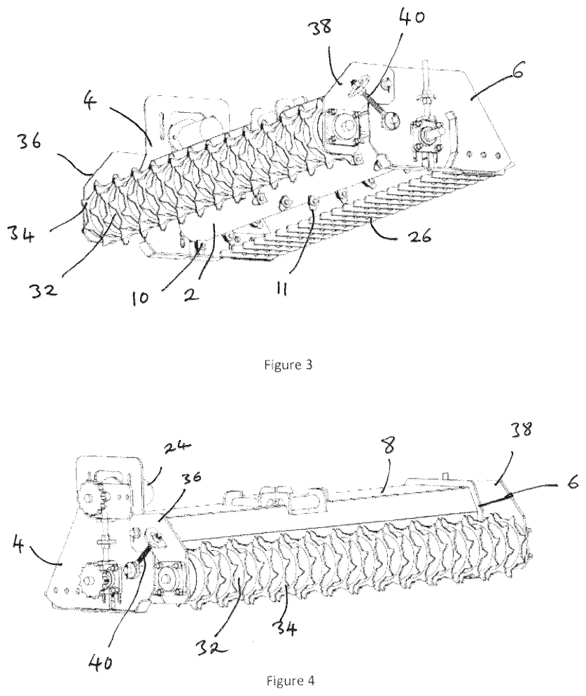

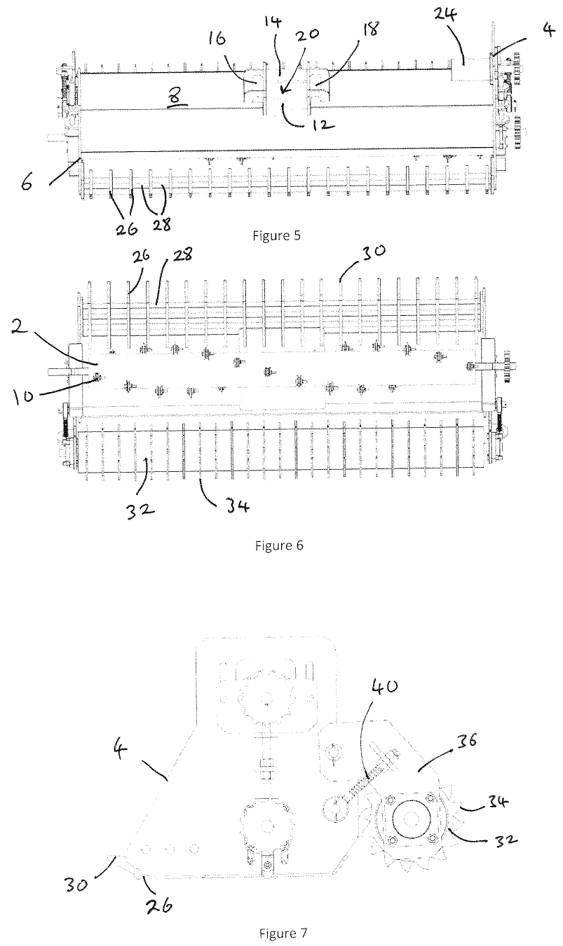

In the embodiment shown, the ground engaging roller 32 (FIGS. 3, 4, and 6-8) is mounted between a pair of roller support arms 36,38, each roller support arm 36,38 being pivotally coupled to a respective side plate 2,4 about a common pivot axis extending parallel to the axis of the rotor 2. An adjustable linkage, such as in the form of a threaded rod 40, extends between each side plate 4,6 and the respective support arm 36,38 mounted thereon to allow the height of the ground engaging roller 32 to be adjusted with respect to the rotor 2 by adjusting the angle of each support arm 36,38 with respect to the respective side plate 4,6. Each end of the ground engaging roller 32 is mounted in a respective support bearing provided on the respective roller support arm 36,38. As well as controlling the depth of penetration of the teeth 10 of the rotor 2 into the soil, the teeth 34 of the ground engaging roller 32 may also service to condition the soil.

The attachment in accordance with the above described embodiment of the present invention permits conventional excavators, commonly available during landscaping and other works, to be utilised for removing stones, debris and other unwanted material from the surface of the soil while conditioning and levelling the soil. The attachment can be used for soil conditioning, such as tilling, as well as having a grading and levelling functionality. The teeth of the rotor penetrate the soil to rake out debris, stones and rocks and condition the soil for subsequent sowing operations. The teeth of the rotor may be adapted to be easily replaceable when worn.

The rotor and/or the ground engaging roller may be interchanged with ones having different teeth shape/arrangements to provide different ground finishes.

Because the attachment is adapted to be mounted on an excavator or back hoe it can be used in difficult locations, such as steep ground, soft ground, uneven ground, and ground with small/difficult access points.

Because the attachment is adapted to be coupled to an excavator or a back hoe via a conventional quick hitch/coupler it can be quickly attached and detached as needed.

The invention is not limited to the embodiment described herein but can be amended or modified without departing from the scope of the present invention as defined by the following claims, which invention is intended to be limited only by the scope of the appended claims as interpreted according to the principles of patent law including the doctrine of equivalents.

1. An attachment adapted to be coupled to a quick coupler on a dipper arm of an excavator, said attachment comprising a rotor having a plurality of ground engaging teeth mounted thereon and a motor for rotatably driving said rotor.

2. The attachment of claim 1, wherein said ground engaging teeth are mounted on said rotor in one or more spirally extending rows.

3. The attachment of claim 1, wherein said ground engaging teeth include replaceable wear tips.

4. The attachment of claim 1, wherein said rotor is rotatably mounted between a pair of side plates to extend substantially parallel to the ground, in use, with a cover plate extending between said side plates to extend over at least an upper portion of said rotor.

5. The attachment of claim 4, wherein a coupling is provided on said cover plate and adapted to engage a quick coupler provided on a distal end of a dipper arm of an excavator.

6. The attachment of claim 5, wherein said coupling is provided on an upper wall of said cover plate substantially midway between said side plates.

7. The attachment of claim 6, wherein said coupling comprises a pair of spaced apart first coupling bars adapted to be engaged by respective latching hooks of an excavator quick coupler, said first coupling bars extending substantially perpendicular to said side plates such that said attachment is adapted to be coupled to the dipper arm of the excavator via said first coupling bars with said rotor extending transverse to the direction of movement of the dipper arm.

8. The attachment of claim 7, wherein said coupling comprises a pair of spaced apart second coupling bars adapted to be engaged by respective latching hooks of a quick coupler of an excavator, said second coupling bars extending between and substantially perpendicular to said first coupling bars and parallel to said side plates such that said attachment is adapted to be coupled to the dipper arm of the excavator via said second coupling bars with said rotor substantially aligned with the direction of movement of the dipper arm.

9. The attachment of claim 4, wherein said motor is mounted on one of said side plates, said motor being drivingly coupled to said rotor via a drive chain or drive belt.

10. The attachment of claim 4, wherein a row of mutually spaced apart skids are mounted between said side plates extending parallel to said side plates, wherein said skids are adapted to engage the ground to facilitate control of the depth to which said teeth of said rotor extend into the ground, in use.

11. The attachment of claim 10, wherein said skids comprise elongate tines or plates arranged parallel to one another and mounted on transversely extending support bars extending between said side plates.

12. The attachment of claim 11, wherein a distal end of each said skid extends beyond said side plates to enable said distal ends of said skids to be used as a rake when said attachment is held in an orientation with said distal ends of said skids facing downwardly.

13. The attachment of claim 12, wherein said distal ends of said skids are shaped to define pointed teeth.

14. The attachment of claim 10, wherein a ground engaging roller is mounted between said side plates to extend parallel to said rotor on an opposite side of said rotor to said skids.

15. The attachment of claim 14, wherein said ground engaging roller is mounted to be adjustable in height with respect to said rotor.

16. The attachment of claim 15, wherein said ground engaging roller is mounted between roller support arms, each roller support arm being pivotally coupled to a respective side plate about a common pivot axis extending parallel to said rotor, with an adjustable linkage extending between the respective side plate and the respective support arm to allow the height of said ground engaging roller to be adjusted with respect to said rotor by adjusting the angle of each support arm with respect to the respective side plate.

17. The attachment of claim 15, wherein each adjustable linkage comprises a threaded rod.

18. The attachment of claim 16, wherein said ends of said ground engaging roller are mounted in bearings provided on said roller support arms.

19. The attachment of claim 14, wherein said ground engaging roller is provided with radially extending teeth extending from said outer surface thereof.

20. The attachment of claim 1, wherein said motor comprises a hydraulic motor.
